(19) United States
(12) Patent Application Publication
(10) Pub. No.: US 2023/0205946 A1
(43) Pub. Date: Jun. 29, 2023

(54) METHOD FOR STRUCTURALLY OPTIMIZING A BRAKE CALIPER

(71) Applicant: HL MANDO CORPORATION, Pyeongtaek-si (KR)

(72) Inventors: Hatem SHAHIN, Pfaffenhofen (DE); Kai BRAUN, Friedrichsdorf (DE); Lothar WAGNER, Simmern (DE)

(73) Assignee: HL MANDO CORPORATION, Pyeongtaek-si (KR)

(21) Appl. No.: 18/088,049

(22) Filed: Dec. 23, 2022

(30) Foreign Application Priority Data
Dec. 23, 2021 (DE) 102021215028.4

(51) Int. Cl. G06F 30/20; G06F 30/15

(52) U.S. Cl. CPC G06F 30/20; G06F 30/15; G06F 2113/10

(57) ABSTRACT

The invention concerns a method for the structural optimization of a brake caliper (10), the brake caliper (10) having a first face (24) and a second face (26) that are spaced apart from one another along a piston movement axis (A), wherein the first and second face (24, 26) are connected by a bridge section (22) of the caliper (10), wherein the method is performed based on a computer-implemented model (30) of the brake caliper (10), caliper model, the method comprising:
prescribing a boundary condition according to which an orientation of the first face (24) and the second face (26) relative to one another and/or to the piston movement axis (A) remains constant even under load;
performing a structural optimization of the caliper model (30) taking into account said boundary condition.

Also disclosed is a brake caliper (10).

This application claims the benefit of priority to German Patent Application No. 102021215028.4, filed on Dec. 23, 2021, the entire content of which is incorporated herein by reference.

The invention relates to a method for structurally optimizing a brake caliper, the brake caliper being in particular configured for a wheel brake of a motor vehicle, such as a car or a truck.

Brake calipers are typically used in the prior art to support and carry at least one brake pad that is movable relative to a braked member. The braked member may in particular be a brake disc. The brake caliper may also be referred to as a caliper frame.

Typically, the brake caliper receives at least part of the braked member and/or faces opposite sides of the braked member. This way, a pair of brake pads can be arranged on opposite sides of the braked member. In a generally known manner, the brake pads can thus clamp the braked member in between them.

Each brake pad is arranged at one of a first and second face of the brake caliper and specifically at a so called finger side or piston side thereof. Said faces and side sides lie on opposite sides of the braked member and/or are spaced apart from one another along a rotational axis of the braked member.

A prior art example of a brake caliper can be found in KR 2009 007718 A.

During brake activation, large forces act on the brake caliper. The brake caliper may thus elastically deform or, put differently, elastically deflect. This can be accompanied with a number of disadvantages. For example, an uneven wear of the brake pads and specifically of their brake linings may occur. This may result in further problems, such as the generation of drag torque or noise. Furthermore, a hydraulic volume absorbed by the brake caliper and more specifically by a hydraulic chamber comprised by the brake caliper may increase as a result of said deformation. This additional brake fluid volume absorption is generally undesired for brake performance and/or safety reasons.

When developing brake calipers, simulations and structural optimisations with help of computer implemented models of the brake caliper are typically performed. So far, it requires a lot of experience and iterations until certain targets are met, e.g. with regard to elastic deformation. Yet, this is often inefficient and does not always guarantee optimal outcomes. For example, this may lead to non-optimal brake caliper designs with respect to other relevant parameters, such as weight.

Also, even though numerous automatic optimization algorithms exist, the efficiency and results of simulation are to large extent still affected by the user. This is because the user defines e.g. the initial model that is to be optimized, the load cases to be considered and the conditions that need to be observed. Thus, achieving optimal results remains a challenge.

It is therefore an object of this disclosure to provide a method for efficiently designing or, put differently, engineering a brake caliper and by means of which at least some of the above disadvantages of existing brake calipers can be limited.

This object is solved by the subject matter according to the attached independent claims. Further advantageous embodiments are disclosed throughout this description and in the dependent claims.

Accordingly, a method for structurally optimizing a brake caliper is disclosed, the brake caliper e.g. comprising or being a caliper frame. The brake caliper has a first face and a second face that are spaced apart from one another along a piston movement axis (of the brake caliper), wherein the first and second face are connected by a bridge section of the brake caliper.

The method is performed based on a computer-implemented model of the brake caliper, or in other words, based on a computer-implemented caliper model.

The method comprises:
prescribing (or defining) a boundary condition according to which an orientation of the first face and the second face relative to one another and/or to the piston movement axis remains constant under load;
performing a structural optimization of the caliper model taking into account said boundary condition.

Generally, it has been determined that as a result of the elastic deformation of existing brake calipers a significant deformation or deflection of the first and second faces carrying the brake pads and/or lying on opposite sides of the brake member may occur. As a result, an axial distance between said faces may increase and may locally vary. For example, the faces may slightly tilt with respect to one another and/or with respect to the rotational axis of the braked member. They may thus assume a non-parallel orientation and/or may generally become slanted, in particular at different angles compared to one another. This may result in an uneven widening of a gap between the faces and/or in uneven axial local deflection and displacement across and within each face. This may promote uneven wear of the brake pads.

Accordingly, the above method suggests a definition of a boundary condition that is suitable for preventing this change in orientation and/or uneven axial deflection of the first and second face. Advantageously, this opens up possibilities for structural optimisation (and in particular weight reduction) in other regions of the brake caliper, while still ensuring a suitable deformation behaviour.

Therefore, a structural optimisation observing said boundary condition may deliver a brake caliper design that prevents an uneven deformation of the brake caliper faces, while still achieving improvement with regard to other target variables, such as weight, stiffness or volume.

The method disclosed herein may at least partially be performed by a computer. All steps and measures of the method may thus be automatically implemented and/or may be automatically carried out by a computer. Generally, the method may be performed as part of a CAE-process (computer aided engineering).

Nonetheless, at least some steps and measures, preferably other than the structural optimisation, may be performed manually and/or under manual control and/or based on manual inputs. This may e.g. concern the prescribing of boundary conditions or of admissible parameters, the setting of optimisation targets as well as the identification of certain regions having defined optimisation targets or conditions, such as an admissible local stiffness (see below).

The brake caliper may, at least prior to the structural optimisation, have a design or a shape that is similar to known configurations. In particular, it may already comprise any of the bridge section, the first and second faces, a hydraulic chamber, a receiving section discussed below and any of the other structural features discussed herein. As a result of the structural optimization, however, the design may be changed, e.g. by adjusting relative arrangements or dimensions of said structural features and/or by changing the shapes of the brake caliper portions connecting them. The structural optimisation may also be referred to as topology optimisation.

The first face and the second face may face each other. They may extend in parallel to one another and/or at the same (preferably orthogonal) angle to the piston movement axis. The may be planar or non-planar, e.g. by being curved or by having a varying shape.

The first and second face may at least partially confine a space, a recess or a gap in which a braked member, in particular a brake disc, may at least partially be received. The first and second face may define at least part of opposite (inner) side faces confining said space or gap. The side faces may extend in parallel to or along the braked member. At or adjacent to each side face, a brake pad may be arrangeable.

In one of said first and second face, an opening may be provided through which a brake piston may be movable, e.g. to act on a brake pad arranged at said side. This side may also be referred to as the piston side of the brake caliper.

The brake caliper may comprise a piston receiving section for receiving a brake piston. For example, the piston receiving section may be or comprise a hollow cylinder for receiving and/or at least partially housing the piston. The piston movement axis may extend concentrically to said piston receiving section and/or the brake piston. In one example, the piston movement axis extends orthogonally to a plane of an opening of the piston receiving section to the outside. The piston receiving section may form at least part of a hydraulic chamber by means of which movement forces can be exerted onto the brake piston.

The piston movement axis may extend in parallel to the movement axes of the brake pads and/or orthogonally to the first and second face and/or in parallel to a rotation axis of the braked member. Generally, from the structure of a given brake caliper, a position of brake pads arranged thereat and/or of a brake piston received therein can be unambiguously determined. Accordingly, the structure of the brake caliper may unambiguously define the orientation and position of the piston movement axis.

The axial distance between the first and second face may amount to several centimeters, for example to more than 5 centimeters or to more than 10 centimeters.

The bridge section can connect the first and second face by extending axially in between them and/or merging with them at edges of the bridge section. The bridge section can cross a gap or a space confined by said faces and in which the braked member and/or the brake pads are at least partially received. The bridge section may form part of an upper (possibly opened or not-fully closed) side of said gap or space, e.g. by forming a bottom or top side thereof.

In one example, the bridge section comprises at least one rib or web that e.g. spans the axial space or gap between the first and second face. Generally, the bridge section may extend along or in parallel to the piston movement axis. In one example, it extends at a smaller angel relative thereto (e.g. less than half) compared to the angles at which the first and second face extend relative to the piston movement axis.

The caliper model may a virtual model or a data-based model. It may be a digital or mathematical representation of the brake caliper. It may include information on the shape, structure and/or material of the brake caliper. It may include or be a CAD (computer aided design) or FE (finite element) model of the brake caliper. It may include model elements, such as nodes, geometric primitives or grids that may e.g. be connected to one another to define a shape of the model.

Prescribing the boundary condition may be done directly by a user (e.g. by entering it in a computer program that implements the method or at least the structural optimization). Alternatively, the boundary condition may automatically be determined and/or prescribed by said computer program, e.g. based on pre-defined rules that are applied to the caliper model, or indirectly based on user inputs.

The considered load may be a mechanical load occurring (or expected) during brake activation. It may be or comprise a pressure exerted onto each of the first and second face. In one example, a maximum expected and/or admissible load is considered. This may be a maximum expected load that the brake caliper is supposed to withstand.

The maximum load may be defined by customer requirements and/or by a manufacturer of the brake caliper. Additionally or alternatively, it may be based on admissible operating scenarios of the brake caliper for which use of the brake caliper is supposed to be certified and/or admitted. In one example, the maximum load may occur when applying a predetermined hydraulic pressure of e.g. more than 50 bar during brake activation or more than 100 bar or more than 150 bar (e.g. up to 200 bar or more).

The structural optimization of the brake caliper model may be performed automatically (i.e., in a computer-implemented manner) and in particular with help of any computer program discussed herein. For example, structural optimization algorithms as known in the prior art may be employed. Such algorithms are implemented in existing CAE software programs, such as Ansys or Catopo.

A novel contribution of this disclosure is to be seen in providing the disclosed boundary condition that is to be considered by the structural optimization performed by such algorithms. This boundary condition may help to ensure that a desired deflection characteristic for limiting disadvantages of existing brake calipers is achieved at an optimized and in particular lighter structure of the brake pad.

Generally, the structural optimization may take the intended manufacturing methods and in particular the manufacturing restrictions and capabilities associated therewith into account. In consequence, shapes, wall thicknesses, radii and the like may be limited and optimised accordingly to meet said restrictions.

According to an embodiment, the brake caliper may be intended for being manufactured by generative manufacturing methods. This may in particular include 3D-printing, selective laser melting or laser sintering. Preferably the generative manufacturing method may use a metallic material out of which the brake caliper is to be manufactured or a material composition including metal.

So far, brake calipers are typically produced from cast iron. Their design is thus restricted by the characteristics of the casting processes. By using generative manufacturing methods said casting restrictions are at least partially removed. Advantageously, generative manufacturing methods are characterised by larger degrees of freedom, e.g. with respect to producible shapes, wall thickness transitions, density variations, hollow structures and the like.

Presently, it has surprisingly been found that a significant structural optimisation is possible by using generative manufacturing methods, even though the presently disclosed restrictive boundary condition is implemented (i.e. the boundary condition limiting the admissible deflection of the first and second face). In case of using casting processes (which is still generally possible according to this disclosure), in order to fulfil said boundary condition the mass and/or volume of the brake caliper will typically have to be increased. To the contrary, when using generative manufacturing methods, the caliper's structure can more freely be altered compared to casting. As a result, the stiffness can be increased to meet the boundary conditions while still achieving some weight reduction.

In one example, the method includes a dedicated step of manufacturing the brake caliper based on the structurally optimized caliper model and by means of a generative manufacturing process.

According to a further embodiment, prescribing the boundary condition includes:
selecting a plurality of nodes or other model elements comprised by the first face and a plurality of nodes or other model elements comprised by the second face; and
prescribing for each of the first and second face a uniform axial deflection of their respective nodes or other model elements.

The other model elements may e.g. be geometric primitives, such as triangles or other polygons. The may represent the smallest (e.g. spatial) entity making up or defining the structure of the model. By selecting a respective plurality of nodes, a subset of model elements of the geometric model can be defined. For doing so, the user may e.g. manually select at least some of the respective model elements in a virtual representation of the model.

The uniform axial deflection for each of the selected model elements may include each of said model elements (and thus the overall face) being displaced by a similar distance along the piston movement axis. Therefore, rotations relative to said axis of a respective face comprising said model elements may be excluded. In one example, the axial deflection of the selected model elements of the first face may occur in a first (e.g. positive) direction along the piston movement axis, whereas the axial deflection of the selected model elements of the second face may occur in an oppositely oriented second (e.g. negative) direction along the piston movement axis. This results in an axial widening of a gap or space enclosed by the first and second face.

The uniform axial deflection may e.g. include that (or be defined as) the distances between any selected nodes or other models elements of the first and second face that lie axially directly opposite to one another change by equal amounts. Lying directly opposite to one another may include that the model elements are connectable by a straight that is parallel to the piston movement axis. For example, at least three nodes or model elements may generally be selected per face. They may be arranged in respective directly oppositely arranged pairs. The changes in axial distances between the nodes or model elements of each pair may be identical for each pair.

In one embodiment, the uniform axial deflection of the first face is different from the uniform axial deflection of the second face. Said faces may thus be displaced by different (e.g. absolute) distances. Specifically, each of the first and second face may maintain their orientations relative to one another and/or to the piston movement axis, while the respective extends (e.g. distances) of the axial displacement may differ. This opens up further degrees of freedom for the structural optimisation.

According to a further aspect, no or at least less restrictive boundary conditions are prescribed for deformations of the first and second face in directions extending at an angle and in particular orthogonally to the piston movement axis. For example, no or at least less restrictive boundary conditions may be defined in a circumferential direction (e.g. referring to the circumference of a braked brake disc) or in a direction extending orthogonally to the bridge section.

A boundary condition may be considered less restrictive if it allows for a greater degree of change in the relative orientation of the first and second face to one another and/or to the piston movement axis. Additionally or alternatively, a boundary condition may be considered less restrictive if it allows for larger deviations between the displacements of the first and second faces in a respective additional direction.

By defining no or less restrictive boundary conditions in such additional directions, the degrees of freedom for a structural optimisation may increase.

In a further embodiment, the structural optimization is performed with respect to at least one of the following targets, e.g. defined as target variables or target parameters that should be improved as a result of the structural optimisation:
weight, in particular in form of a reduction of weight;
deformation behavior (or, put differently, deformation characteristics) and/or stiffness, in particular in form of lowering the extent of deformation or deflection and/or increasing the stiffness at least in selected regions of the brake caliper;
natural frequency, in particular in form of shifting it to desired frequency ranges that are e.g. suitable for limiting noise generation and/or vibrations;
mass distribution, in particular in form of concentrating mass in areas absorbing a large amount of deformation energy and/or reducing it in other areas;
additional brake fluid intake during brake activation, in particular in form of maintaining the volume of additional brake fluid intake below of a predetermined threshold (e.g. lower than 5% or lower than 2% at maximum brake pressure and/or compared to a desired or set brake fluid intake). Reference is made to the above-discussed known problem of existing brake calipers absorbing additional brake fluid as a result of the elastic deformation during braking.

In a further embodiment, the method includes defining locally admissible degrees of stiffness within the brake caliper. For example, the method may include defining at least one region of the brake caliper in which a comparatively lowered stiffness is admissible and/or defining at least one region of the brake caliper in which a comparatively increased stiffness is admissible. The reference for the comparatively lower or increase stiffness may be an average or a predetermined stiffness. Additionally or alternatively, the stiffness of said regions may be compared to one another to determine a respectively lowered and increased stiffness. The change in stiffness may amount to at least 10% or at least 20% with respect to any of the above references.

The structural optimization may take the locally admissible degrees of stiffness into account, e.g. so that these are fulfilled by the optimised structure. For example, a positioning and/or dimensioning of at least one portion in said at least one region having a respectively lowered or increased stiffness may be varied during optimisation. That is, the structural optimisation may locally vary and/or locally adjust the stiffness in order to meet the optimisation target while taking the admissible stiffnesses into account.

By defining locally admissible degrees of stiffness (e.g. prior to performing the structural optimisation), a suitable deflection behaviour may be at least roughly be defined. The admissible stiffnesses may represent a further boundary condition and/or a starting point of the optimisation. Providing the admissible stiffnesses may increase efficiency of the structural optimisation and may improve the results achieved thereby.

For example, based on experience or based on preferences with regard to deflection, regions may be defined which are marked by a higher stiffness (e.g. to ensure the consistent orientation of the first and second face under load), compared to other regions marked by a lower stiffness (e.g. to allow for a less material being deposited therein and/or for acting as a deliberately deflectable portion).

Any stiffness may generally be defined herein as e.g. an E modulus, a poissons's ratio or a G modulus.

Additionally or alternatively, at least one region may be defined in which a structural optimisation with respect to any of the targets discussed herein may not be carried out. This may be referred to as a non-design region. It may include any of the first and second face. Alternatively, the structural optimisation in said at least one region may be carried out with respect to different targets or not with respect to all of the targets that are considered in other regions of the brake caliper.

Put differently, at least one region of the caliper may be deliberately excluded from the structural optimisation at least with respect to selected optimisation targets. As a result, the quality and/or efficiency of the optimisation may be increased, e.g. due to lowering the complexity of the structural optimisation.

The structural optimisation may be carried out with respect to the complete brake caliper, or, as noted above, only with respect to selected regions. In one example, the structural optimisation is at least or is only applied to a region comprising (at least part of) the bridge section. It has been determined that this section has a large potential for structural optimisation and at the same time can ensure that the boundary condition is met.

For example, the structural optimization may include varying and/or determining at least one of the following with respect to at least one form feature or at least one section of the brake caliper, the form feature or section being preferably comprised by the bridge section:
a positioning of said form feature or section;
an orientation of said form feature or section;
a dimensioning of said form feature or section;
a density of said form feature or section;
a stiffness of said form feature or section.

As is generally known in optimisation, after each variation implications on at least one target of the optimisation may be determined to successively approximate an optimal result.

The form feature may e.g. be one of a recess or cut-out, a rib or web, a (e.g. locally) thinned portion, a (e.g. locally) thickened portion. The thinned or thickened portion may be thinned or thickened with respect to neighbouring portions (e.g. by more than 20%) and/or with respect to an average, initial or predetermined thickness (preferably of the bridge section).

The density may be varied particularly efficiently when applying generative manufacturing methods, e.g. by varying an extent of local material depositions or local material solidifications accordingly. It may e.g. be used by to set the stiffness of the form feature or section as desired.

Especially when applying generative manufacturing methods, any structural parameters and in particular the stiffness or density can be defined in a direction-dependent manner. For example, the density, an E modulus or a G modulus can be defined independently with respect to each axis of a brake caliper coordinate system.

According to a further embodiment, an admissible deformation of the bridge is prescribed as a further boundary condition for the structural optimization, in particular a permissible axial deformation.

Additionally or alternatively, an admissible deformation in at least one region of the bridge section may be increased relative to adjacent regions (e.g. of the bridge section or of other sections of the brake caliper adjacent to the bridge section). For example, said region may comprise a transition region to or merging region with one of the first face and the second face.

Accordingly, in particular at edge regions of the bridge section where said bridge section connects to one of the first and second face, an admissible deformation may be increased and/or the bridge section's stiffness may be lowered. It has been found that this helps to fulfil the boundary condition while efficiently meeting optimization targets.

The invention also concerns a brake caliper according to any of the embodiments disclosed herein and/or resulting from or produced according to any of the structural optimizations disclosed herein.

For example, the brake caliper may have a first face and a second face that are spaced apart from one another along a piston movement axis, wherein the first and second face are connected by a bridge section, wherein an orientation of the first face and the second face relative to one another and/or to the piston movement axis remains constant under load, in particular even under a maximum load defined above.

The brake caliper may comprise any of the following further structural features, alone or in any combination, each feature promoting that the above orientations are maintained. Note that any of features from the below list can also form part of a method according to any of the embodiments disclosed herein. This concerns in particular a selection of design parameters and prescription of additional boundary conditions discussed below.
Compared to the remainder of the bridge section and e.g. to an average or maximum stiffness thereof, a stiffness at (axial) edge portions or connection portions of the bridge section may be lowered.

Said edge portions or connection portions may each be connected to adjacent caliper regions (e.g. to the first or second face).
An average material thickness, a weight or a volume of material within the bridge section may be lower than in brake caliper portions connected by the bridge section. A density or a number or volume of any of hollow sections, ribs and cut-outs within the bridge section may be higher than in brake caliper portions connected by the bridge section.
The stiffness and/or density of the brake caliper may vary in between different caliper regions, e.g. by more than 20%. It may in particular be lowered in the bridge section.
A number and/or position of stiffenening structures, such as ribs or webs, can be appropriately set. It can be larger in the bridge portion than in other portions of the brake caliper (where the number can also be zero). A user can define said number, e.g. as a minimum, maximum or exactly desired number. Said number can represent an additional boundary condition for the structural optimization.
The bridge section can have a higher strength than sections of the brake caliper connected thereto (e.g. than the piston side or finger side). Generally, strength data can be prescribed, e.g. as a boundary condition for the structural optimization. In one example, the strength can be or define a yield stress and can be set so as to avoid plastic deformation.
If stiffening structures are provided, e.g. ribs or webs and/or in particular within the bridge section, a ratio between their cross section area and their length can be set to avoid buckling under load. For example, a respective minimum ratio can be prescribed as a boundary condition of the structural optimization. If the cross-section varies, sectionally adjusted ratios can be defined.
The caliper can comprise a least one cut-out or cavity, in particular within the bridge section. Apart from saving weight and promoting the desired deformability, this can ensure an advantageous air circulation and thus cooling. The cut-out or cavity can have a predetermined minimum size. For example, an area enclosed thereby can amount to at least 5%, at least 10% or at least 20% of a footprint area of the brake caliper (e.g. the footprint when viewed in an inwardly oriented radial direction when arranged at a brake disc). Also, a respective minimum size of the cut-out or cavity be set by a user, e.g. as an additional boundary condition for the structural optimization.

Further, the method according to any of the embodiments disclosed may include any of the following measures, alone or in any combination. Also, the brake caliper may be derived based on a method and in particular a structural optimization that employs any of these measures:
A factor of safety can be set, e.g. in the context of load or stress calculation during structural optimization. This factor may be set to ensure durability with respect to fatigue load cases. In one example, the factor of safety can be larger than 0,5%, e.g. at least 1%.
Thermal expansion values of the used material(s) for producing the brake caliper can be considered during structural optimization, e.g. to avoid over-loaded thermal cracks or other damage.
For at least a predetermined number of Eigenfrequencies (e.g. the first three to five Eigenfrequencies), an explicit value or explicit value range may be set. The first Eigenfrequeny can be set to be as large as possible.
Further targets apart from deformability and e.g. strength may be considered, e.g. when refining or, finally selecting a design retrieved from structural optimization. These targets may e.g. concern manufacturing, transport or storage aspects, such as associated costs, space requirements or manufacturing time. Additionally or alternatively, crash behavior may be examined, as typically available in common CAE software took.

Embodiments of the invention are discussed below with reference to the appended schematic figures. Throughout the figures, same features may be marked with same references signs.

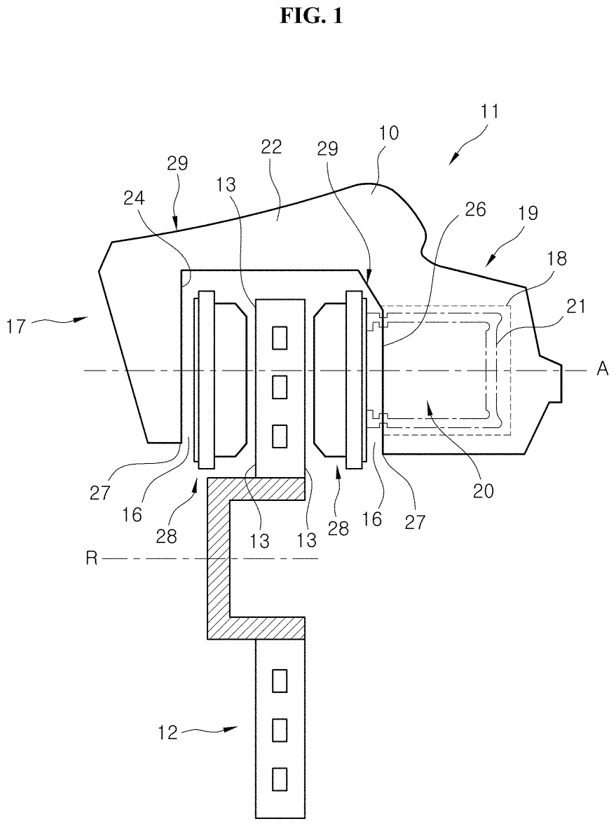

FIG. 1 is a view of a prior art brake caliper that is to be structurally optimized;

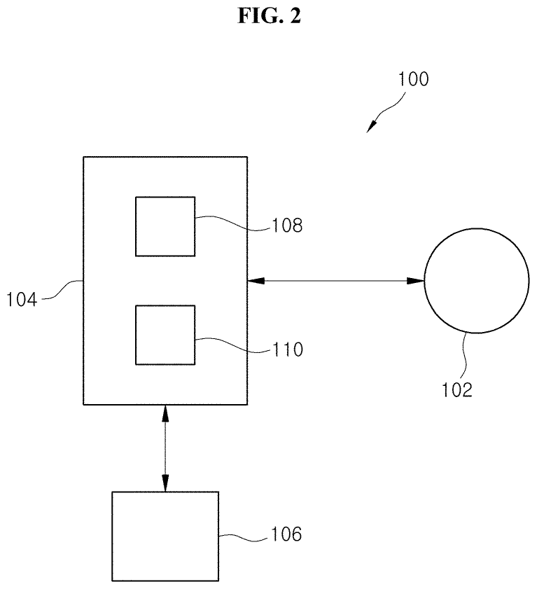

FIG. 2 is a view of a system for implementing a method according to an embodiment of the invention;

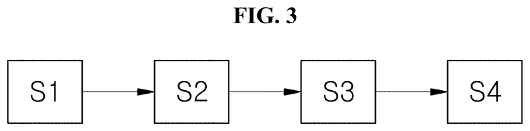

FIG. 3 is a flow diagram indicating the steps of a method according to an embodiment of this invention;

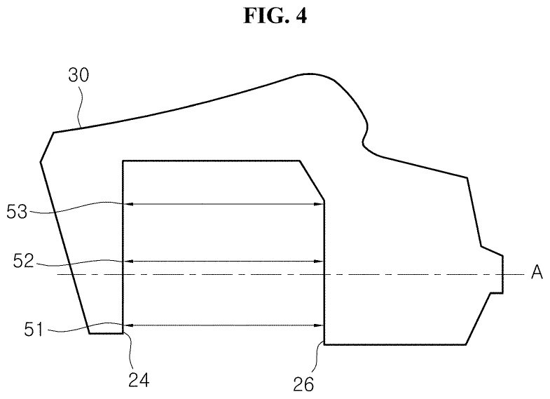

FIG. 4 is a view of a brake caliper used in the method of FIG. 3 and with locally varying of degrees of an admissible stiffness.

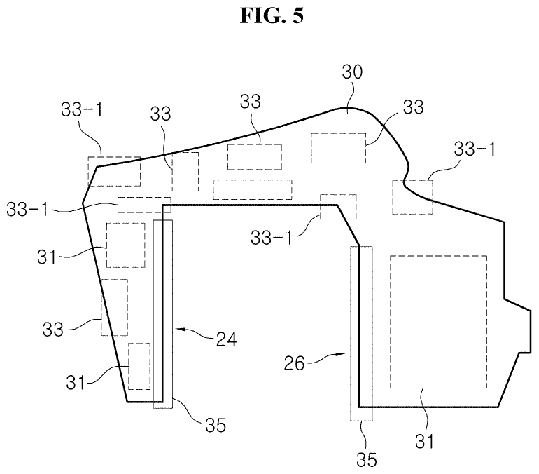

FIG. 5 is an illustration of the caliper model for which an additional or alternative boundary condition is defined.

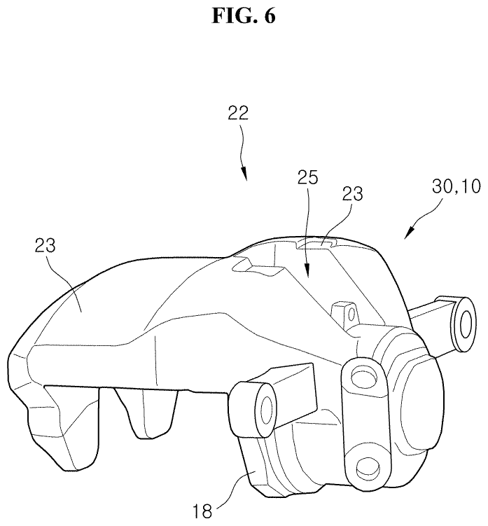

FIG. 6-8 show a comparison between a non-optimized brake caliper and structurally optimized brake calipers according to an embodiment of the invention.

In FIG. 1, a brake caliper 10 of a wheel brake assembly 11 is shown. The brake caliper 10 is generally configured according to known prior-art examples, i.e. its structure not having been optimized according to this disclosure. The view of FIG. 1 is a cross-sectional view with the cross-sectional plane extending vertically and including a rotational axis R. A non-depicted vehicle wheel rotates about said rotational axis R. The non-depicted vehicle wheel is disposed (in FIG. 1) to the left of a brake disc 12 that equally rotates about the rotational axis R.

The brake caliper 10 axially spans across the brake disc 12 and receives at least a radially outer portion thereof. Specifically, the brake caliper 10 has a gap of space 14 receiving at least a radially outer edge section of the brake disc 12. The gap or space 14 has two inner sides 16 extending substantially orthogonally with respect to the rotational axis R and each facing an outer side face 13 of the brake disc 12. Specifically, in FIG. 1 a left inner side 16 faces a left outer side face 13 and a right inner side 16 faces a right outer side face 13. The brake caliper 10 is thus arranged to face opposite sides of the brake disc 12.

The brake caliper 10 has a cylindrical receiving section 18 for receiving a brake piston 20 and for delimiting a hydraulic chamber 21. A side or portion of the brake caliper 10 comprising said receiving section 18 may be referred to as a piston side. The piston 20 is movable along a piston movement axis A which extends in parallel to the rotational axis R.

The brake caliper 10 has a bridge section 22. It extends substantially axially and connects the piston side 19 with a region or portion of the brake caliper 10 located at the opposite of the brake disc 12. This region or portion may be referred to as finger side 17. Non-depicted guide pins on which the brake caliper 10 is axially slidingly guided preferably extend from the piston side 19 up to the finger side 17.

The finger side 17 and piston side 19 each delimit the space 14 for receiving the brake disc 12. Specifically, the each comprise one of the inner sides 16 (or, put differently, inner faces). Further, said inner sides 16 are comprised by a first and second face 24, 26 of the brake caliper 10, respectively.

FIG. 1 further shows brake pads 28. One brake pad 28 is arranged at each of the first and second face 24, 26. The brake pads 28 thus face opposite side faces 13 of the brake disc 12. In a generally known manner, the piston 20 can be moved along the piston movement axis A to press the (in FIG. 1 right) brake pad 28 at the second face 26 against the opposite side faces 13 of the brake disc 12. When further increasing the hydraulic pressure at the piston 20, the brake caliper 10 slides to the right of FIG. 1 along the non-depicted guide pins until the brake disc 12 is clamped between both brake pads 28.

Existing brake systems suffer from inhomogeneous brake pad wear, excessive brake noise generation and excessive additional brake fluid intake by the hydraulic chamber 21 during braking at e.g. high hydraulic pressures. It has presently been determined that this typically results from non-uniform axial widening of the space or gap 14. Specifically, the inner sides 14 and thus first and second face 24, 26 may change their initially typically upright orientation. They may thus become slanted. An axial distance between their radially inner or lower edges 27 often increases to larger extent than between their radially outer or upper edges 29. In other words, the first and second face 24, 26 may change from an initially parallel orientation to extending obliquely to one another.

Referring to FIG. 4 and as discussed in further detail below, this may result in the axial distances L1-L3 becoming different from one another and/or in these distances L1-L3 changing by different degrees under load. In particular, the radially lower distance L3 may increase to a larger extent than the radially outer distances L1, L2.

In order to compensate for this non-uniform axial widening along each of the first and second face 24, 26, a standard approach would include iteratively increasing the mass e.g. near said lower edges 27 or within the bridge section 22. This, however, would increase the overall weight.

Instead, according to a method disclosed herein, a suitable boundary condition has been determined that can be directly implemented into a CAE workflow for preventing the above-discussed undesired deformation. At the same time, however, it allows for an optimization with respect to other targets, such as weight.

FIG. 2 shows a system 100 for implementing the method. The system 100 comprises a user interface arrangement 102 (e.g. comprising any of a mouse, microphone, keyboard, display, touch panel or combinations thereof). The system 100 also comprises a computer device 104, such as a personal computer. Further, the system 100 comprises a generative manufacturing device 106, e.g. a laser sintering device.

The computer device 104 has a processor (e.g. a CPU) 108 and a storage unit 110. The storage unit 110 stores a computer program and/or computer program instructions. These are executed by the processor 108 to implement steps of the method disclosed herein.

Specifically, a computer implemented model of a brake caliper that is to be structurally optimised is stored in the storage unit 110. By way of the user interface arrangement 102, a user can provide any inputs, provide any settings or definitions disclosed herein and e.g. for preparing a structural optimisation of said model. Such inputs, settings and definitions may equally be stored in the storage unit 110. They may include any of the boundary conditions disclosed herein.

Further, by way of the user interface arrangement 102, a structural optimisation algorithm whose computer program instructions are stored in the storage unit 110, can be activated. Said algorithm is applied to the brake caliper model in order to determine an optimised structure of the brake caliper model while further taking the user input, settings and definitions and/or any of the boundary conditions disclosed herein into account. This may also include taking specifics and in particular manufacturing restrictions of the manufacturing device 106 into account.

The structurally optimised model may be transmitted to the generative manufacturing device 106 which may determine suitable control actions to manufacture a real product corresponding to said digital/virtual optimised model. Alternatively, these control actions may be determined by the computer device 104 and then be transmitted to the generative manufacturing device 106.

A sequence of a respectively implemented method is depicted in the flow diagram of FIG. 3. In step S1 the computer implemented model of the brake caliper is generated or provided, said brake caliper having a non-optimised structure. In step S2 any boundary conditions that should be considered during structural optimisation are defined, preferably by being directly inputted by a user. In step S3, the structural optimisation algorithm is executed to structurally optimised be brake caliper model while taking any of the boundary conditions of step S2 into account. In step S4, the structurally optimised model is received and stored, preferably in order to determine control actions for manufacturing a brake caliper according to said model. Of course, in case the result of step S4 is non-satisfying, steps S2 and S3 can iteratively be repeated and/or the initial brake caliper model of step S1 may be adjusted.

With respect to FIGS. 4 and 5, two examples of boundary conditions are discussed that can be set in the context of step S2 of the presently disclosed method. FIG. 4 shows a representation of the computer implemented caliper model 30. Because said caliper model 30 is a virtual representation of the actual brake caliper 10 depicted in FIG. 1, same reference signs will be used with respect to said model. Accordingly, the first and second face 24, 26 can again be seen.

As a boundary condition, it is defined that under load changes of the axial distance L1, L2, L3 along the piston movement axis A for at least three points, e.g. defined as nodes of the model 30, should be similar. This means that the first and second face 24, 26 remain their relative orientation to one another but also to the piston movement axis A.

For example, the position of three exemplary nodes 51-53 comprised by the first face 24 is indicated in FIG. 4. The boundary condition may prescribe that an axial displacement along the piston movement axis A must be identical for each of said nodes 51-53. Similar requirements may be prescribed by the boundary condition for (non-specifically marked) nodes of the second face 26. As a result, for each node 51-53 the change in the axial distance to a directly opposite node at the opposite face 24, 26 is identical.

A user may define said boundary condition by selecting the respective nodes 51-53 out of a plurality of nodes comprised by the first face 24 (and a respective plurality of nodes comprised by the second face 26) for which any of the above conditions shall apply. Afterwards, he may activate the structural optimisation algorithm and e.g. verify or adjust its results.

FIG. 5 is an illustration of the caliper model 30 for which an additional or alternative boundary condition is defined. According to this boundary condition admissible degrees of stiffness are set for selected regions of the caliper model 30. These regions art marked in FIG. 5 by different outlines.

For example, a dashed outline 31 with an increased line width marks regions with a first admissible stiffness. The dashed outlines 33 having a reduced line width mark regions having a second admissible stiffness. The first admissible stiffness in the regions of the outlines 31 may be larger than the second admissible stiffness in the regions of the outlines 33.

The positioning of said stiffness-regions may be done based on experience and/or according to predetermined rules. For example, a number and/or size of regions 33 having a lower admissible stiffness can be higher in the bridge section 22 compared to the finger side 17 and piston side 19. With respect to the number and/or size of regions 31 having a higher admissible stiffness, the opposite may apply, i.e. they may be predominantly concentrated in and/or may be larger outside of the bridge section 22 than e.g. near at first and second face 24, 26 or generally within the finger side 17 and piston side 19.

As an optional measure, at least some regions 33.1 may be defined having a lowered admissible stiffness and being positioned in a transition region (or edge portion) between the bridge section 22 and one of the piston side 19 or finger side 17. Furthermore, at least one further respective region 33 having a lowered admissible stiffness is optionally placed axially between the edge portions or transition regions at both axial ends or edges of the bridge section 22. This way, the bridge section 22 can as such have a defined axial deformability that helps to fulfil the boundary condition of FIG. 4. For example, this may help to limit the risk of the first and second face 24, 26 tilting with respect to one another, e.g. due to having an excessively stiff connection to the bridge section 22.

Optionally, regions 35 can be defined that are not to be structurally optimized. These include in the depicted example the first and second face 24, 26.

FIGS. 6-C depict a brake caliper model 30 in various stages of the structural optimisation and from different viewing angles. In FIG. 6, the initial model 30 of a brake caliper 10 is provided that has not yet undergone the presently disclosed structural optimisation. The bridge section 22 is marked by at least two comparatively massive axial sections 23 as well as comparatively small a central cut-out 25.

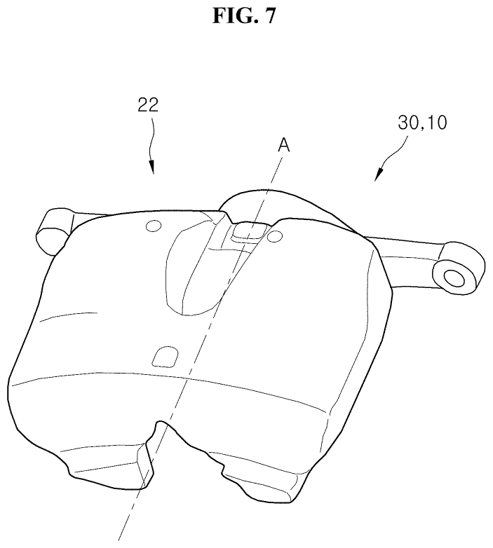

In FIG. 7, the structural optimisation has been carried out for achieving a first (comparatively low) weight reduction target while observing the boundary condition of FIG. 4. As a result, a thickness of the bridge section 22 is at least somewhat reduced and a size of the centre opening 25 is increased.

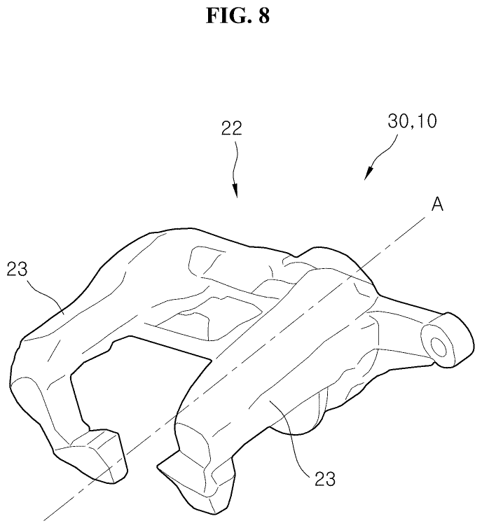

In FIG. 8, the structural optimisation has been carried out for achieving a second (comparatively large) weight reduction target while again observing the boundary condition of FIG. 4. In this case, the mass of the bridge section 22 is significantly reduced e.g. because its axial sections 23 no longer merge with one another on the finger side 17 and are partially hollow. The latter is in particular made possible by using a generative manufacturing method, such as selective laser melting. The axial sections 23 of the bridge section 22 are now connected by a thin rib 27. Also, the volume of the brake caliper 10 at the finger side 17 is significantly reduced.

However, due to an optimised positioning and dimensioning of the rib 27 and of the the axial sections 23, it is ensured that the boundary condition of FIG. 4 is still met.

### LIST OF REFERENCE SIGNS

10 brake caliper
11 wheel brake assembly
12 brake disc
13 side face of the brake disc
14 space or gap
16 inner side (of caliper)
17 finger side
18 receiving section
19 piston side
20 piston
21 hydraulic chamber
22 bridge section
23 axial section of bridge section
24 first face
25 cut out
26 second face
27 lower edge
28 brake pad
29 upper edge
30 caliper model
31, 33, 33.1 regions of defined admissible stiffness
35 non-optimization region
51-53 node
100 system
102 interface arrangement
104 computer
106 generative manufacturing device
108 processor
110 storage unit
A piston movement axis
R rotational axis

1. A method for structurally optimizing a brake caliper (10), the brake caliper (10) having a first face (24) and a second face (26) that are spaced apart from one another along a piston movement axis (A), wherein the first and second face (24, 26) are connected by a bridge section (22) of the caliper (10),
wherein the method is performed based on a computer-implemented model (30) of the brake caliper (10), caliper model, the method comprising:
prescribing a boundary condition according to which an orientation of the first face (24) and the second face (26) relative to one another and/or to the piston movement axis (A) remains constant under load;
performing a structural optimization of the caliper model (30) taking into account said boundary condition.

2. The method of claim 1, further comprising:
manufacturing the brake caliper (10) based on the structurally optimized caliper model (30) and by means of a generative manufacturing process.

3. The method of claim 1,
wherein prescribing the boundary condition includes:
selecting a plurality of nodes (51-53) or other model elements comprised by the first face (24) and a plurality of nodes (51-53) or other model elements comprised by the second face (26); and
prescribing for each of the first and second face (24, 26) a uniform axial displacement of their respective nodes (51-53) or other model elements.

4. The method of claim 3,
wherein the uniform axial displacement of the first face (24) is different from the uniform axial deflection of the second face (26).

5. The method of claim 1,
wherein no or at least less restrictive boundary conditions are prescribed for deformations of the first and second face (24, 26) in directions extending at an angle and in particular orthogonally to the piston movement axis (A).

6. The method of claim 1, further comprising:
wherein the structural optimization is performed with respect to at least one of the following targets:
weight;
deformation behavior and/or stiffness;
natural frequency;
mass distribution;
additional brake fluid intake during brake activation;
thermal distribution within the caliper (10).

7. The method of claim 1,
wherein the method further includes:
defining locally admissible degrees of stiffness within the caliper (10);
wherein the structural optimization takes said locally admissible degrees of stiffness into account.

8. The method of claim 1,
wherein the structural optimization includes varying at least one of the following with respect to at least one form feature or at least one section of the caliper (10), the form feature or section being preferably comprised by the bridge section (22):
a positioning of said form feature or section;
an orientation of said form feature or section;
a dimensioning of said form feature or section;
a density of said form feature or section;
a stiffness of said form feature or section.

9. The method according to claim 8,
wherein the form feature is one of a recess or cut-out (25), a rib (27) or web, a thinned portion, a thickened portion.

10. The method of claim 1,
wherein as a further boundary condition for the structural optimization an admissible deformation of the bridge section (22) is prescribed, in particular a permissible axial deformation.

11. Brake caliper (10),
having a first face (24) and a second face (26) that are spaced apart from one another along a piston movement axis (A), wherein the first and second face (24, 26) are connected by a bridge section (22),
wherein an orientation of the first face (24) and the second face (26) relative to one another and/or to the piston movement axis (A) remains constant under load.
